(19) United States
(12) Patent Application Publication
(10) Pub. No.: US 2012/0008555 A1
(43) Pub. Date: Jan. 12, 2012

(54) TRANSMIT AND RECEIVE PROCESSING IN THE PRESENCE OF INTERFERENCE IN A WIRELESS NETWORK

(75) Inventors: Xiaoxia ZHANG, San Diego, CA (US); Tao LUO, San Diego, CA (US); Taesang YOO, San Diego, CA (US)

(73) Assignee: QUALCOMM INCORPORATED, San Diego, CA (US)

(21) Appl. No.: 13/166,742

(22) Filed: Jun. 22, 2011

Related U.S. Application Data
(60) Provisional application No. 61/357,943, filed on Jun. 23, 2010.

(51) Int. Cl. H04W 4/00

(52) U.S. Cl. 370/328

(57) ABSTRACT

A method for communicating in a wireless network includes receiving a signal intended to be spread over a first subcarrier and a second subcarrier. The method also includes determining the first subcarrier is subject to interference, and in this case decoding the received signal on the second subcarrier without demodulating the signal on the first subcarrier. The signal is intended to be spread in the frequency domain over multiple subcarriers or intended to be coded based on SFBC (space frequency block codes). The first and second subcarriers may be consecutive. Rate matching around the first stream or puncturing of the first stream enables proper decoding of the SFBC stream. Changing the spreading factor enables proper decoding in the case of frequency domain spreading over multiple streams.

### CROSS-REFERENCE TO RELATED APPLICATION

This application claims the benefit under 35 U.S.C. §119(e) to U.S. Provisional Patent Application No. 61/357,943 entitled “Transmit and Receive Processing in the Presence of Interference in a Wireless Network,” filed on Jun. 23, 2010, the disclosure of which is expressly incorporated by reference herein in its entirety.

### BACKGROUND

1. Field

Aspects of the present disclosure relate generally to wireless communication systems, and more particularly to rate matching around interference in a heterogeneous network.

2. Background

Wireless communication networks are widely deployed to provide various communication services such as voice, video, packet data, messaging, broadcast, etc. These wireless networks may be multiple-access networks capable of supporting multiple users by sharing the available network resources.

A wireless communication network may include a number of base stations that can support communication for a number of user equipments (UEs). The UE and base station may communicate via the downlink and uplink. The downlink (or forward link) refers to the communication link from the base station to the UE, and the uplink (or reverse link) refers to the communication link from the UE to the base station.

On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes receiving a signal intended to be spread over a first subcarrier and a second subcarrier. When it is determined the first subcarrier is subject to interference, the received signal is decoded on the second subcarrier without demodulating the signal on the first subcarrier.

In another aspect, a method of wireless communication discloses generating a signal to be spread over a first subcarrier and a second subcarrier. The signal corresponds to multiple streams. The first subcarrier is determined to be subject to interference and the signal is transmitted on fewer than all streams over the second subcarrier.

Another aspect discloses an apparatus including means for receiving a signal intended to be spread over a first subcarrier and a second subcarrier. Also included is a means for determining the first subcarrier is subject to interference and means for decoding the received signal on the second subcarrier without demodulating the signal on the first subcarrier.

In another aspect, an apparatus includes means for generating a signal to be spread over a first subcarrier and a second subcarrier where the signal corresponds to multiple streams. Also included is a means for determining the first subcarrier is subject to interference and means for transmitting the signal on fewer than all streams over the second subcarrier.

Another aspect discloses a computer program product for wireless communications in a wireless network. The computer readable medium has program code recorded thereon which, when executed by the processor(s), causes the processor(s) to perform operations of receiving a signal intended to be spread over a first subcarrier and a second subcarrier. The program code also causes the processor(s) to determine the first subcarrier is subject to interference. The program code causes the processor(s) to decode the received signal on the second subcarrier without demodulating the signal on the first subcarrier.

In another aspect, a computer program product for wireless communications in a wireless network is disclosed. The computer readable medium has program code recorded thereon which, when executed by the processor(s), causes the processor(s) to perform operations of generating a signal to be spread over a first subcarrier and a second subcarrier. The signal corresponds to multiple streams. The program code also causes the processor(s) to determine if the first subcarrier is subject to interference, in which case the program code causes the processor(s) to transmit the signal on fewer than all streams over the second subcarrier.

In another aspect, a wireless communication apparatus has a memory and at least one processor coupled to the memory is disclosed. The processor(s) is configured to receive a signal intended to be spread over a first subcarrier and a second subcarrier. The processor(s) is also configured to determine the first subcarrier is subject to interference, in which case the processor(s) is configured to decode the received signal on the second subcarrier without demodulating the signal on the first subcarrier.

Another aspect discloses a wireless communication apparatus having a memory and at least one processor coupled to the memory. The processor(s) is configured to generate a signal to be spread over a first subcarrier and a second subcarrier. The signal corresponds to multiple streams. The processor(s) is configured to determine the first subcarrier is subject to interference, in which case the processor(s) is also configured to transmit the signal on fewer than all streams over the second subcarrier.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a diagram conceptually illustrating an example of a downlink frame structure in a telecommunications system.

FIG. 3 is a block diagram conceptually illustrating an example frame structure in uplink communications.

FIG. 4 is a block diagram conceptually illustrating a design of a base station/eNodeB and a UE configured according to one aspect of the present disclosure.

FIG. 5 is a block diagram conceptually illustrating adaptive resource partitioning in a heterogeneous network according to one aspect of the disclosure.

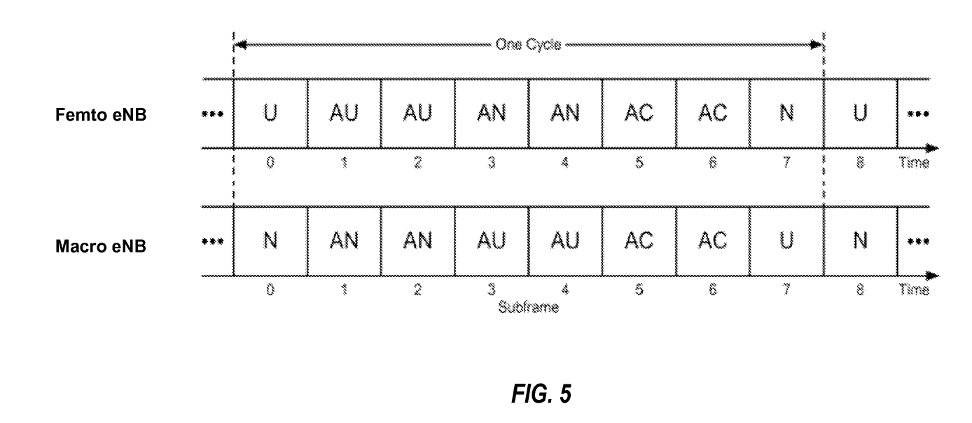

FIG. 6 is a diagram illustrating transmitting on two consecutive subcarriers.

FIGS. 7A and 7B illustrate sets of spreading sequences over subcarriers.

FIGS. 8A and 8B are block diagrams illustrating a method for processing transmitted and received signals in the presence of strong interference.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

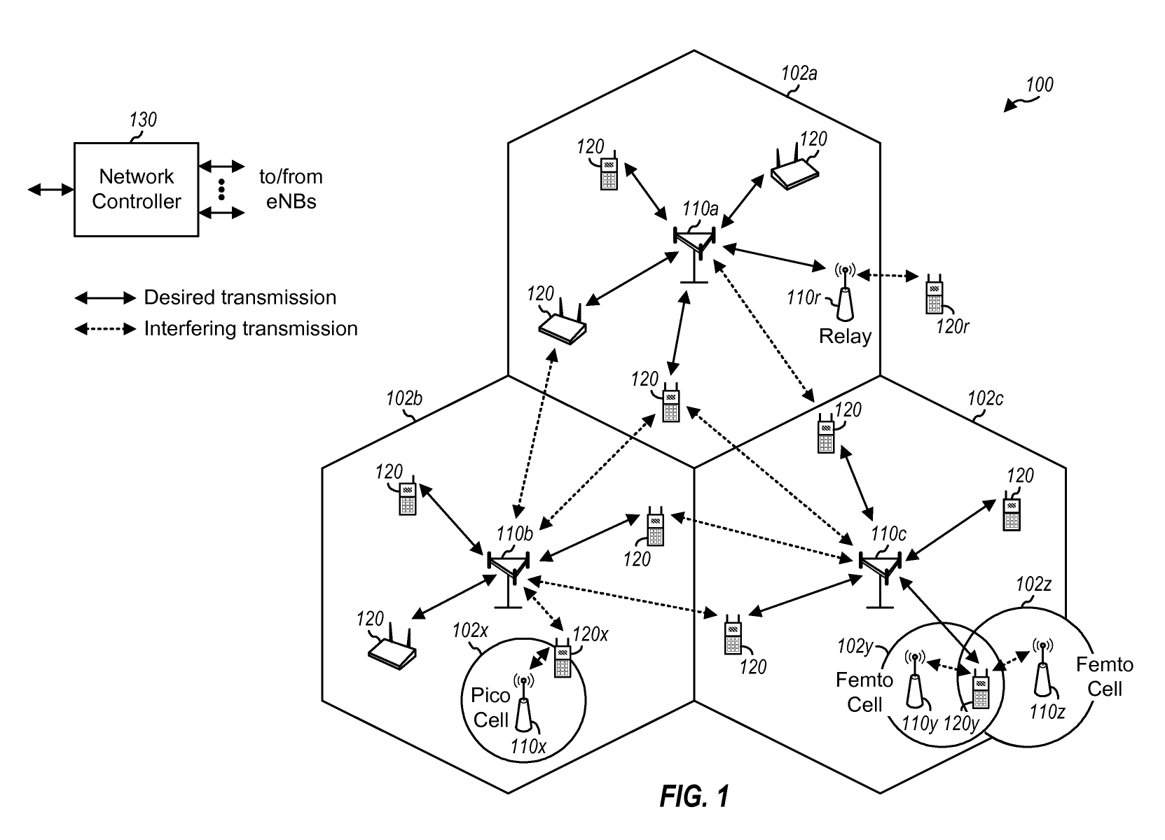

FIG. 1 shows a wireless communication network 100, which may be an LTE-A network. The wireless network 100 includes a number of evolved node Bs (eNodeBs) 110 and other network entities. An eNodeB may be a station that communicates with the UEs and may also be referred to as a base station, a node B, an access point, and the like. Each eNodeB 110 may provide communication coverage for a particular geographic area. In 3GPP, the term “cell” can refer to this particular geographic coverage area of an eNodeB and/or an eNodeB subsystem serving the coverage area, depending on the context in which the term is used.

An eNodeB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNodeB for a macro cell may be referred to as a macro eNodeB. An eNodeB for a pico cell may be referred to as a pico eNodeB. And, an eNodeB for a femto cell may be referred to as a femto eNodeB or a home eNodeB. In the example shown in FIG. 1, the eNodeBs 110a, 110b and 110c are macro eNodeBs for the macro cells 102a, 102b and 102c, respectively. The eNodeB 110x is a pico eNodeB for a pico cell 102x. And, the eNodeBs 110y and 110z are femto eNodeBs for the femto cells 102y and 102z, respectively. An eNodeB may support one or multiple (e.g., two, three, four, and the like) cells.

The wireless network 100 may also include relay stations. A relay station is a station that receives a transmission of data and/or other information from an upstream station (e.g., an eNodeB, UE, etc.) and sends a transmission of the data and/or other information to a downstream station (e.g., a UE or an eNodeB). A relay station may also be a UE that relays transmissions for other UEs. In the example shown in FIG. 1, a relay station 110r may communicate with the eNodeB 110a and a UE 120r in order to facilitate communication between the eNodeB 110a and the UE 120r. A relay station may also be referred to as a relay eNodeB, a relay, etc.

The wireless network 100 may be a heterogeneous network that includes eNodeBs of different types, e.g., macro eNodeBs, pico eNodeBs, femto eNodeBs, relays, etc. These different types of eNodeBs may have different transmit power levels, different coverage areas, and different impact on interference in the wireless network 100. For example, macro eNodeBs may have a high transmit power level (e.g., 20 Watts) whereas pico eNodeBs, femto eNodeBs and relays may have a lower transmit power level (e.g., 1 Watt).

In one example, the wireless network 100 supports synchronous operation. For synchronous operation, the eNodeBs may have similar frame timing, and transmissions from different eNodeBs may be approximately aligned in time. In one aspect, the wireless network 100 may support Frequency Division Duplex (FDD) or Time Division Duplex (TDD) modes of operation. The techniques described herein may be used for either FDD or TDD mode of operation.

A network controller 130 may couple to a set of eNodeBs 110 and provide coordination and control for these eNodeBs 110. The network controller 130 may communicate with the eNodeBs 110 via a backhaul. The eNodeBs 110 may also communicate with one another, e.g., directly or indirectly via a wireless backhaul or a wireline backhaul.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a laptop computer, a cordless phone, a wireless local loop (WLL) station, a tablet, or the like. A UE may be able to communicate with macro eNodeBs, pico eNodeBs, femto eNodeBs, relays, and the like. In FIG. 1, a solid line with double arrows indicates desired transmissions between a UE and a serving eNodeB, which is an eNodeB designated to serve the UE on the downlink and/or uplink. A dashed line with double arrows indicates interfering transmissions between a UE and an eNodeB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for a corresponding system bandwidth of 1.25, 2.5, 5, 10 or 20 megahertz (MHz), respectively. The system bandwidth may also be partitioned into sub-bands. For example, a sub-band may cover 1.08 MHz (i.e., 6 resource blocks), and there may be 1, 2, 4, 8 or 16 sub-bands for a corresponding system bandwidth of 1.25, 2.5, 5, 10, 15 or 20 MHz, respectively.

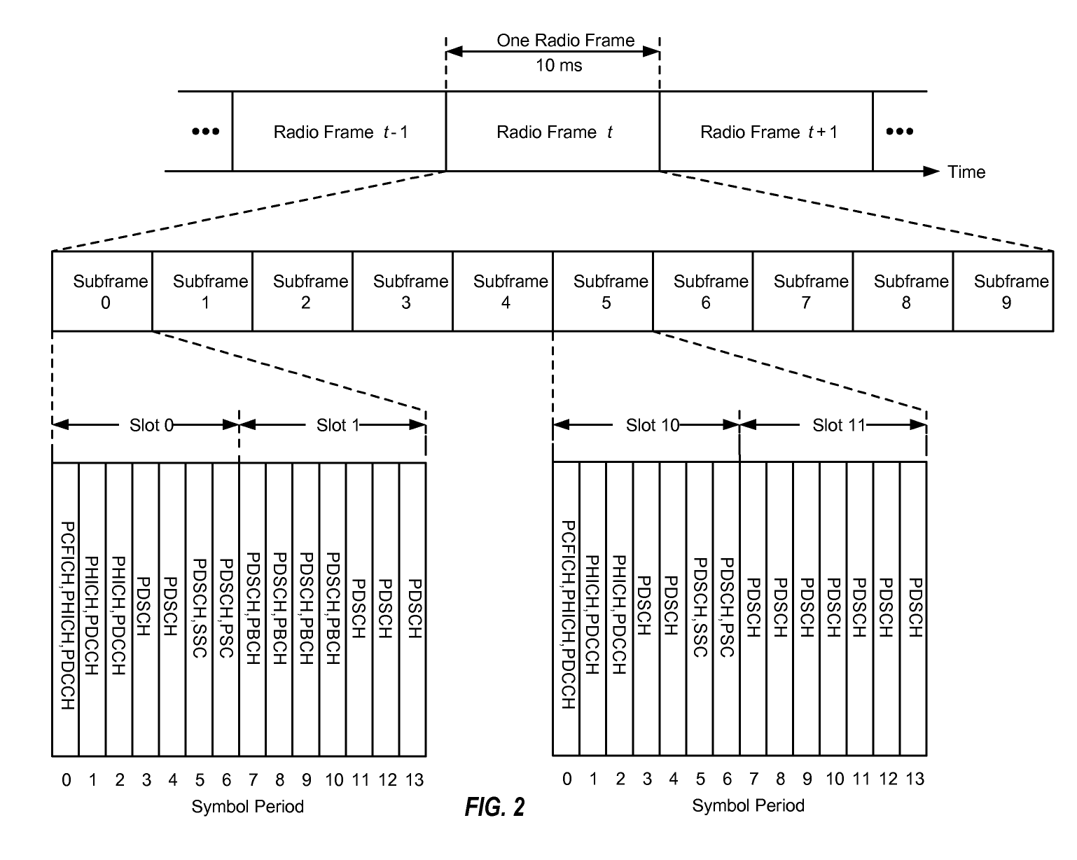

FIG. 2 shows a downlink FDD frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNodeB may send a primary synchronization signal (PSC or PSS) and a secondary synchronization signal (SSC or SSS) for each cell in the eNodeB. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

The eNodeB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNodeB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on uplink and downlink resource allocation for UEs and power control information for uplink channels. The eNodeB may send a Physical Downlink Shared Channel (PDSCH) in the remaining symbol periods of each subframe. The PDSCH may carry data for UEs scheduled for data transmission on the downlink.

The eNodeB may send the PSC, SSC and PBCH in the center 1.08 MHz of the system bandwidth used by the eNodeB. The eNodeB may send the PCFICH and PHICH across the entire system bandwidth in each symbol period in which these channels are sent. The eNodeB may send the PDCCH to groups of UEs in certain portions of the system bandwidth. The eNodeB may send the PDSCH to groups of UEs in specific portions of the system bandwidth. The eNodeB may send the PSC, SSC, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. For symbols that are used for control channels, the resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 36 or 72 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for all UEs in the PDCCH. An eNodeB may send the PDCCH to the UE in any of the combinations that the UE will search.

A UE may be within the coverage of multiple eNodeBs. One of these eNodeBs may be selected to serve the UE. The serving eNodeB may be selected based on various criteria such as received power, path loss, signal-to-noise ratio (SNR), etc.

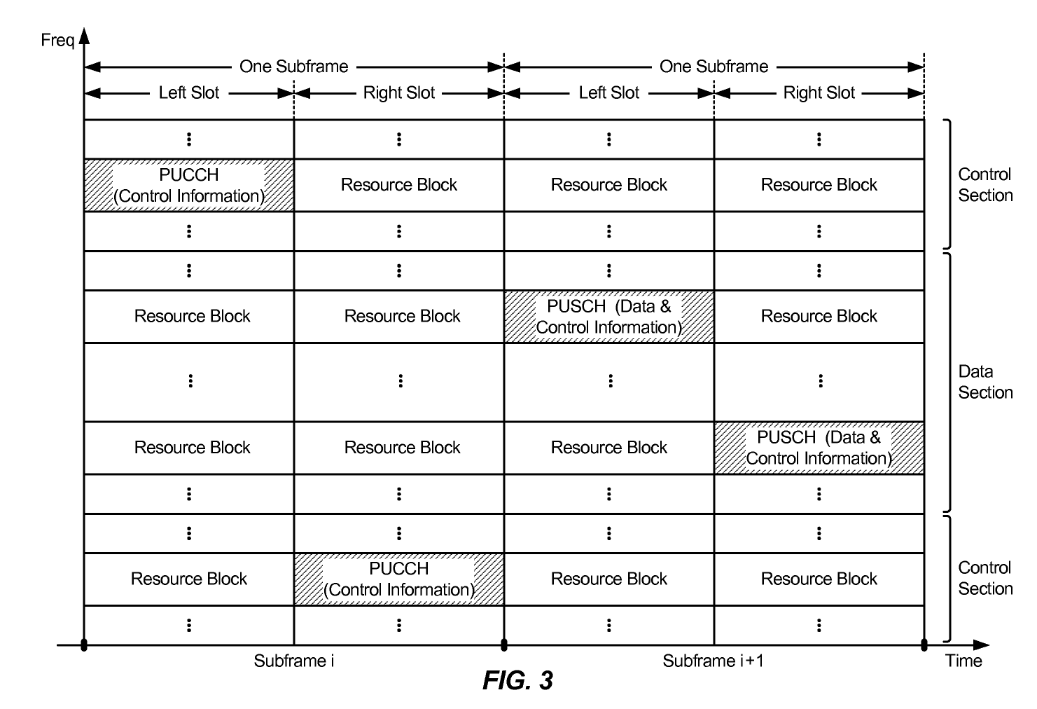

FIG. 3 is a block diagram conceptually illustrating an exemplary FDD and TDD (non-special subframe only) subframe structure in uplink long term evolution (LTE) communications. The available resource blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 3 results in the data section including contiguous subcarriers, which may allow a single UE to be assigned all of the contiguous subcarriers in the data section.

A UE may be assigned resource blocks in the control section to transmit control information to an eNodeB. The UE may also be assigned resource blocks in the data section to transmit data to the eNode B. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 3. According to one aspect, in relaxed single carrier operation, parallel channels may be transmitted on the UL resources. For example, a control and a data channel, parallel control channels, and parallel data channels may be transmitted by a UE.

The PSC, SSC, CRS, PBCH, PUCCH, PUSCH, and other such signals and channels used in LTE/-A are described in 3GPP TS 36.211, entitled “Evolved Universal Terrestrial Radio Access (E-UTRA); Physical Channels and Modulation,” which is publicly available.

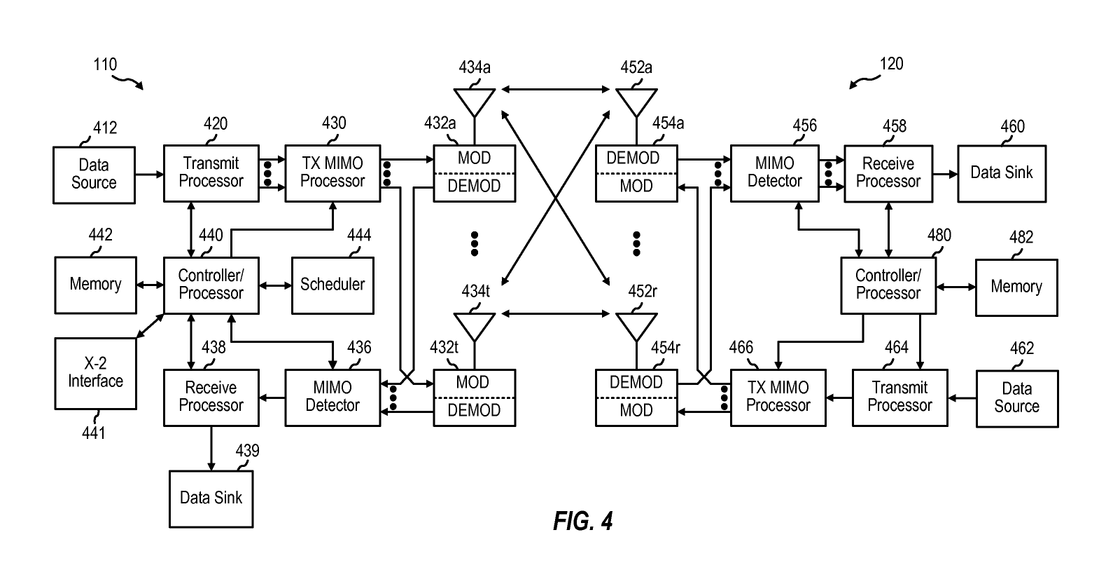

FIG. 4 shows a block diagram of a design of a base station/eNodeB 110 and a UE 120, which may be one of the base stations/eNodeBs and one of the UEs in FIG. 1. The base station 110 may be the macro eNodeB 110c in FIG. 1, and the UE 120 may be the UE 120y. The base station 110 may also be a base station of some other type. The base station 110 may be equipped with antennas 434a through 434t, and the UE 120 may be equipped with antennas 452a through 452r.

At the base station 110, a transmit processor 420 may receive data from a data source 412 and control information from a controller/processor 440. The control information may be for the PBCH, PCFICH, PHICH, PDCCH, etc. The data may be for the PDSCH, etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at the UE 120, a transmit processor 464 may receive and process data (e.g., for the PUSCH) from a data source 462 and control information (e.g., for the PUCCH) from the controller/processor 480. The processor 464 may also generate reference symbols for a reference signal. The symbols from the transmit processor 464 may be precoded by a TX MIMO processor 466 if applicable, further processed by the modulators 454a through 454r (e.g., for SC-FDM, etc.), and transmitted to the base station 110. At the base station 110, the uplink signals from the UE 120 may be received by the antennas 434, processed by the demodulators 432, detected by a MIMO detector 436 if applicable, and further processed by a receive processor 438 to obtain decoded data and control information sent by the UE 120. The processor 438 may provide the decoded data to a data sink 439 and the decoded control information to the controller/processor 440. The base station 110 can send messages to other base stations, for example, over an X2 interface 441.

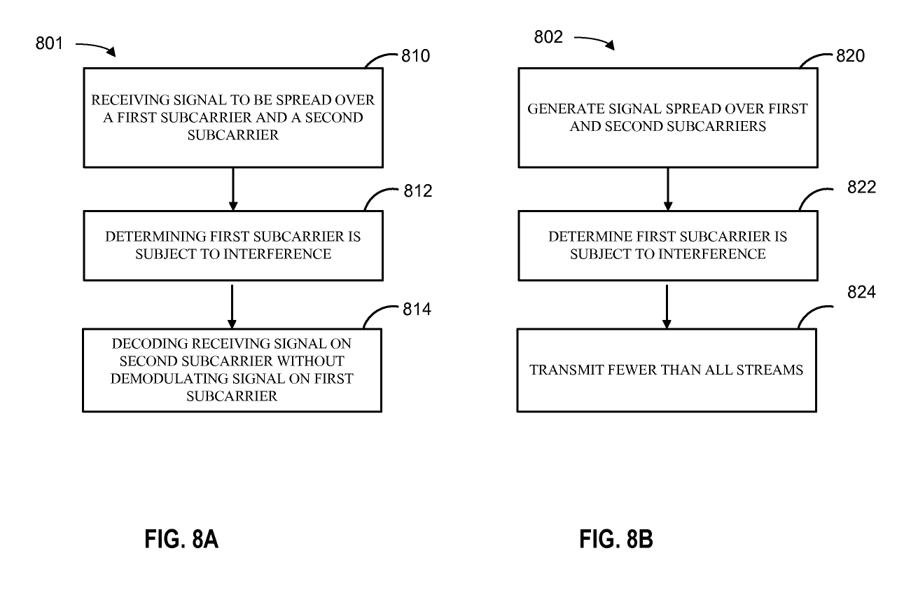

The controllers/processors 440 and 480 may direct the operation at the base station 110 and the UE 120, respectively. The processor 440 and/or other processors and modules at the base station 110 may perform or direct the execution of various processes for the techniques described herein. The processor 480 and/or other processors and modules at the UE 120 may also perform or direct the execution of the functional blocks illustrated in use method flow chart FIGS. 8, and/or other processes for the techniques described herein. The memories 442 and 482 may store data and program codes for the base station 110 and the UE 120, respectively. A scheduler 444 may schedule UEs for data transmission on the downlink and/or uplink.

A UE may be within the coverage of multiple eNodeBs and one of these eNodeBs may be selected to serve the UE. The serving eNodeB may be selected based on various criteria such as, but not limited to, received power, path loss, signal to noise ratio (SNR), etc. In deployments of heterogeneous networks, such as the wireless network 100, a UE may operate in a dominant interference scenario in which the UE may observe high interference from one or more interfering eNodeBs.

In deployments of heterogeneous networks, such as the wireless network 100, a UE may operate in a dominant interference scenario in which the UE may observe high interference from one or more interfering eNodeBs. A dominant interference scenario may occur due to restricted association. For example, in FIG. 1, the UE 120y may be close to the femto eNodeB 110y and may have high received power for the eNodeB 110y. However, the UE 120y may not be able to access the femto eNodeB 110y due to restricted association and may then connect to the macro eNodeB 110c (as shown in FIG. 1) or to the femto eNodeB 110z also with lower received power (not shown in FIG. 1). The UE 120y may then observe high interference from the femto eNodeB 110y on the downlink and may also cause high interference to the eNodeB 110y on the uplink. Using coordinated interference management, the eNodeB 110c and the femto eNodeB 110y may communicate over the backhaul to negotiate resources. In the negotiation, the femto eNodeB 110y agrees to cease transmission on one of its channel resources, such that the UE 120y will not experience as much interference from the femto eNodeB 110y as it communicates with the eNodeB 110c over that same channel.

In addition to the discrepancies in signal power observed at the UEs in such a dominant interference scenario, timing delays of downlink signals may also be observed by the UEs, even in synchronous systems, because of the differing distances between the UEs and the multiple eNodeBs. The eNodeBs in a synchronous system are presumptively synchronized across the system. However, for example, considering a UE that is a distance of 5 km from the macro eNodeB, the propagation delay of any downlink signals received from that macro eNodeB would be delayed approximately 16.67 μs (5 km÷3×108, i.e., the speed of light, ‘c’). Comparing that downlink signal from the macro eNodeB to the downlink signal from a much closer femto eNodeB, the timing difference could approach the level of a time tracking loop (TTL) error.

A dominant interference scenario may also occur due to range extension, which is a scenario in which a UE connects to an eNodeB with lower signal to noise ratio (SNR) among the eNodeBs detected by the UE. For example, in FIG. 1, the UE 120x may detect the macro eNodeB 110b and the pico eNodeB 110x and may have lower received power for the eNodeB 110x than the eNodeB 110b. Nevertheless, it may be desirable for the UE 120x to connect to the pico eNodeB 110x if the path loss for the eNodeB 110x is lower than the path loss for the macro eNodeB 110b. This may result in less interference to the wireless network for a given data rate for the UE 120x.

With range extension enabled in a wireless network, such as the wireless network 100, in order for UEs to obtain service from a lower power base station (i.e., a pico or femto base station) in the presence of a macro base station with stronger downlink signal strength, or for the UEs to obtain service from a macro base station in the presence of a strongly interfering signal from a femto base station to which the UE is not authorized to connect, an enhanced inter-cell interference coordination (eICIC) may be used to coordinate the interfering base station giving up some resources in order to enable control and data transmissions between the UE and the serving base station. When a network supports eICIC, the base stations negotiate with each other to coordinate resources in order to reduce/eliminate interference by the interfering cell giving up part of its resources. With this, a UE can access the serving cell even with severe interference by using the resources yielded by the interfering cell.

A coverage lapse within a macro cell may exist when a femto cell with a closed access mode, in which only member femto UEs may access the cell, lies within the coverage area of the macro cell. By making this femto cell give up some of its resources, the UE within the femto cell coverage area may access its serving macro cell by using the resources yielded by the femto cell. In a radio access system using OFDM such as E-UTRAN, these yielded resources may be time-based, frequency-based, or a combination of both. When the yielded resources are time-based, the interfering cell refrains from using some of its accessible subframes in the time domain. When these resources are frequency-based, the interfering cell does not use some of its accessible subcarriers in the frequency domain. When the yielded resources are a combination of both frequency and time, the interfering cell does not use the resources defined by frequency and time.

For a UE that supports eICIC, the existing criteria for analyzing radio link failure (RLF) conditions may not satisfactorily address the conditions of the coordinating cells. When the UE lies in a region with severe interference where the interference is coordinated between base stations by the interfering cell giving up part of its resources, the UE measurement of the signal to noise ratio or the decoding error rate of PDCCH may vary considerably, depending on whether the resources were yielded by the interfering cell. When the UE measures the signal to noise ratio or the decoding error rate of the PDCCH for the resources which were not yielded by the interfering cell, the UE can erroneously declare an RLF due to high interference, although the UE can still access the serving cell using the resources yielded by the interfering cell.

Heterogeneous networks may use inter-cell interference coordination (ICIC) to reduce interference from cells in co-channel deployment. One ICIC mechanism is time division multiplexing (TDM) partitioning. In TDM partitioning, subframes are assigned to certain eNodeBs. In subframes assigned to a first eNodeB, neighbor eNodeBs do not transmit. Thus, interference experienced by a UE served by the first eNodeB is reduced. Subframe assignment may be performed on both the uplink and downlink channels.

For example, subframes may be allocated between three classes of subframes: protected subframes (U subframes), prohibited subframes (N subframes), and common subframes (C subframes). Protected subframes are assigned to a first eNodeB for use exclusively by the first eNodeB. Protected subframes may also be referred to as “clean” subframes based on the lack of interference from neighboring eNodeBs. Prohibited subframes are subframes assigned to a neighbor eNodeB, and the first eNodeB is prohibited from transmitting data during the prohibited subframes. For example, a prohibited subframe of the first eNodeB may correspond to a protected subframe of a second interfering eNodeB. Thus, the first eNodeB is the only eNodeB transmitting data during the first eNodeB's protected subframe. Common subframes may be used for data transmission by multiple eNodeBs. Common subframes may also be referred to as “unclean” subframes because of the possibility of interference from other eNodeBs.

At least one protected subframe is statically assigned per period. In some cases only one protected subframe is statically assigned. For example, if a period is 8 milliseconds, one protected subframe may be statically assigned to an eNodeB during every 8 milliseconds. Other subframes may be dynamically allocated.

Adaptive resource partitioning information (ARPI) allows the non-statically assigned subframes to be dynamically allocated. Any of protected, prohibited, or common subframes may be dynamically allocated (AU, AN, AC subframes, respectively). The dynamic assignments may change quickly, such as, for example, every one hundred milliseconds or less.

Heterogeneous networks may have eNodeBs of different power classes. For example, three power classes may be defined, in decreasing power class, as macro eNodeBs, pico eNodeBs, and femto eNodeBs. When macro eNodeBs, pico eNodeBs, and femto eNodeBs are in a co-channel deployment, the power spectral density (PSD) of the macro eNodeB (aggressor eNodeB) may be larger than the power spectral density of the pico eNodeB and the femto eNodeB (victim eNodeBs) creating large amounts of interference with the pico eNodeB and the femto eNodeB. Protected subframes may be used to reduce or minimize interference with the pico eNodeBs and femto eNodeBs. That is, a protected subframe may be scheduled for the victim eNodeB to correspond with a prohibited subframe on the aggressor eNodeB.

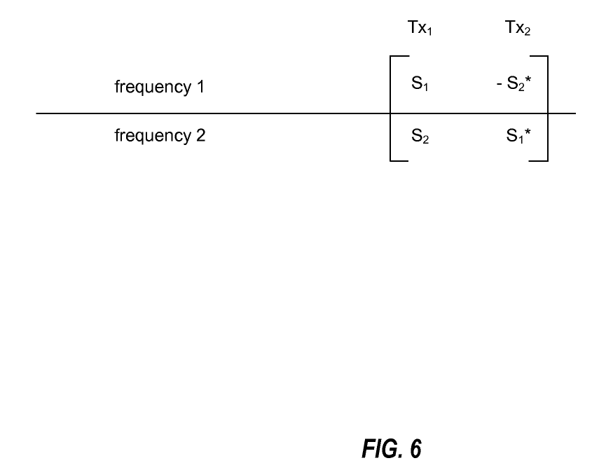

FIG. 6 is a block diagram illustrating TDM partitioning in a heterogeneous network. A first row of blocks illustrate sub frame assignments for a femto eNodeB, and a second row of blocks illustrate sub frame assignments for a macro eNodeB. Each of the eNodeBs has a static protected sub frame during which the other eNodeB has a static prohibited sub frame. For example, the femto eNodeB has a protected sub frame (U sub frame) in sub frame 0 corresponding to a prohibited sub frame (N sub frame) in sub frame 0. Likewise, the macro eNodeB has a protected sub frame (U sub frame) in sub frame 7 corresponding to a prohibited sub frame (N sub frame) in sub frame 7. Sub frames 1-6 are dynamically assigned as either protected sub frames (AU), prohibited sub frames (AN), and common sub frames (AC). During the dynamically assigned common sub frames (AC) in sub frames 5 and 6, both the femto eNodeB and the macro eNodeB may transmit data.

Protected sub frames (such as U/AU sub frames) have reduced interference and a high channel quality because aggressor eNodeBs are prohibited from transmitting. Prohibited sub frames (such as N/AN sub frames) have no data transmission to allow victim eNodeBs to transmit data with low interference levels. Common sub frames (such as C/AC sub frames) have a channel quality dependent on the number of neighbor eNodeBs transmitting data. For example, if neighbor eNodeBs are transmitting data on the common sub frames, the channel quality of the common sub frames may be lower than the protected sub frames. Channel quality on common sub frames may also be lower for extended boundary area (EBA) UEs strongly affected by aggressor eNodeBs. An EBA UE may belong to a first eNodeB but also be located in the coverage area of a second eNodeB. For example, a UE communicating with a macro eNodeB that is near the range limit of a femto eNodeB coverage is an EBA UE.

Another approach to reduce problems from interference is implementing reference signal-interference cancellation (RS-IC) at the receiver to cancel out the interference from the stronger eNodeB. However, interference cancellation increases complexity at the receiver. Thus, it would be desirable to eliminate or reduce interference without employing interference cancellation.

With space frequency block codes (SFBC) one interfering subcarrier may affect two subcarriers because SFBC relies on two consecutive subcarriers for demodulation. SFBC is widely used, for example, on control and data channels in LTE. In SFBC a two-by-two block is created which is sent over two transmit antenna via two carriers. For the first carrier, antenna 1 transmits symbol s1 and antenna 2 transmits symbol minus s2 conjugate. For the second carrier antenna 1 transmits symbol s2 and antenna 2 transmits symbol s1 conjugate. For example, in FIG. 6, for SFBC transmitting on two consecutive frequencies (frequency 1, frequency 2) and two symbols, the first transmit antenna (Tx1) transmits symbol S1 for frequency 1 and symbol S2 for frequency 2. The second transmit antenna (Tx2) transmits minus S2 conjugate S2* on frequency 1 and the S1 conjugate S1* on frequency 2. A receiver receives both symbols and uses the symbols to decode the content. In other words, the content is spread over both symbols.

If one subcarrier sees strong interference, then the symbols on the adjacent subcarrier will also be affected. In order for the receiver to decode the symbols, the whole block must be received. For example, if one subcarrier is knocked out (for example due to interference), then decoding the symbols on the other subcarrier will not be possible, due to loss of some of the symbols (on the interfered subcarrier).

Optionally, in one aspect of the present disclosure, if one of the subcarriers suffers from severe interference, the receiver may utilize the knowledge for demodulation. In particular, the receiver may not use the signal received over the subcarriers suffering from interference. The receiver can still demodulate the stream which is sent on the non-interfered subcarriers. Such receiver processing may be better suited when there is a corresponding transmitter operation.

If one of these two subcarriers suffers from severe interference it would be beneficial to have a procedure in place on both the transmitter and receiver to avoid intensive interference cancellation.

Similar to SFBC, frequency domain spreading relies on N subcarriers for despreading. One interfering subcarrier affects N subcarriers because despreading relies on N subcarriers. Frequency domain spreading may be used, for example, on downlink (DL) acknowledgement channels such as the physical hybrid automatic repeat request indicator channel (PHICH) in LTE. The impact of interference is magnified twice with SFBC and N-times with frequency domain spreading over N subcarriers. Thus, there is a need for avoiding interference with SFBC and frequency domain spreading.

In SFBC, if two streams are to be transmitted on the two subcarriers, and one of the two consecutive subcarriers suffers from interference, the transmitter may puncture one stream or rate match around one stream of the two streams. That is, the transmitter does not send one of the streams, thus avoiding use of the subcarrier with interference. The remaining stream is modulated onto the subcarrier without interference.

If the transmitter knows one subcarrier will impact the other subcarrier, the transmitter will lose the information transmitted from the interfering stream. The non-interfering stream can compensate for the loss of data by transmitting as much data as possible, while puncturing data on the interfering stream. For example, in one aspect, data is not transmitted in a particular stream. In particular, if one data stream is experiencing strong interference, then zero (or nothing) may be transmitted for that stream.

The receiver and the transmitter can negotiate and come to an agreement on which, if any, subcarriers have interference present. If two subcarriers are available and if one subcarrier is under interference, then the transmitter and receiver agree that the transmitter will only send one stream modulated on the subcarrier not under interference. Additionally, the transmitter and receiver agree not to send the stream modulated on the subcarrier under interference.

In one aspect, where puncturing is utilized, both symbols s₁ and s₂ are generated. However, for the stream experiencing strong interference, the symbols are punctured. When rate matching is utilized, if symbol s₁ is in the stream experiencing strong interference, then symbol s₁ is not generated. Rather only symbol s2 is generated. In other words, when rate matching is utilized, symbols are only generated for the symbols actually being transmitted. If a symbol is not going to be transmitted, for example, due to interference, then the symbol will not be generated. For rate matching, the UE will typically have some type of change on the decoder side in order to generate only the transmitted symbols.

Frequency domain spreading relies on N subcarriers for despreading. Thus, if one of the N subcarriers suffers from interference, the transmitter may select spreading codes that are orthogonal by ignoring the interfered subcarriers. For example, if the PHICH (physical hybrid automatic repeat request indicator channel) has a spreading factor (SF) of four (4) with normal cyclic prefix (CP), the spreading length may be reduced to SF2. In another example, if the PHICH has a spreading length of two (2) with extended cyclic prefix, the spreading length may be reduced to SF1.

According to one aspect, the spreading length may be selected by the scheduling eNodeB. The eNodeB may schedule the physical uplink shared channel (PUSCH) together with a demodulation reference signal (DMRS) such that the corresponding spreading codes are orthogonal even when the interfered subcarriers are ignored. In particular, when the eNodeB schedules the PUSCH, the eNodeB determines the resource blocks (RBs) on which to send the PUSCH. In one aspect, the eNodeB scheduler ensures the starting resource block and corresponding cyclic shift are sent on the appropriate subcarrier. The scheduler may change the starting resource block and/or cyclic shift.

In one example, when subcarriers N, N+1, N+3, N+4 are available, the transmitter sends a single symbol spread over four subcarriers (or tones). The decoder uses the four subcarriers N, N+1, N+3, N+4 to decode data. Interference on one subcarrier of the four subcarriers may result in the symbol not being properly decoded.

In one example, subcarrier N+4 is under interference. The eNodeB may select a spreading sequence such that when the receiver ignores subcarrier N+4 and subcarrier N+3 it does not lose data. The spreading sequences defined for Rel-8 PHICH do not provide orthogonality over three subcarriers. Thus, if one subcarrier is under interference, two subcarriers may be abandoned and the spreading factor decreased to two (2) with a corresponding reduced multiplexing capability of two (2).

According to one aspect, a new set of sequences of length 3 may be defined that are orthogonal over three subcarriers. That is, a spreading factor 3 (SF3) can be introduced. In this case, the receiver may puncture or rate match around subcarrier N+4 and use only subcarriers N, and N+1 and N+3.

According to one aspect, the eNodeB may transmit a PHICH spread over four subcarriers. When the subcarrier N+4 is under interference, and only spreading factor 2 (SF2) is available, subcarrier N+3 and subcarrier N+4 become unavailable. The receiver then punctures subcarrier N+3 and N+4.

When performing rate matching, the receiver can separate streams from the non-interfered subcarriers if the spreading factor is reduced, meaning multiplexing fewer streams such that those streams being transmitted are still orthogonal over the non-interfered subcarriers. In other words, the remaining subcarriers without interference should be orthogonal.

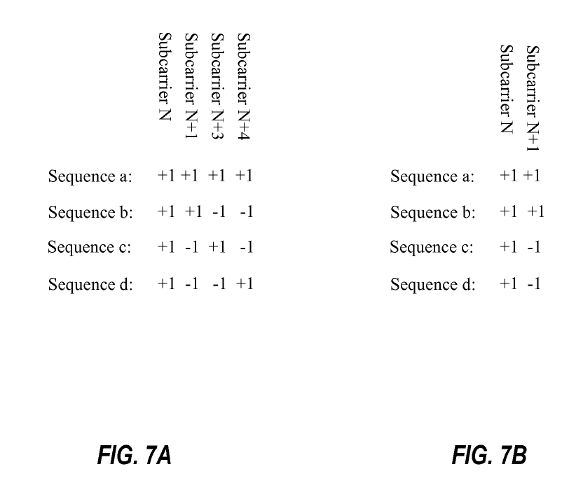

For example, a set of streams with corresponding spreading sequences over subcarriers N, N+1, N+3, N+4 is illustrated in FIG. 7A, where stream a with sequence a is +1 +1 +1 +1; stream b with sequence b is +1 +1 −1 −1; stream c with sequence c is +1 −1 +1 −1; and stream d with sequence d is +1 −1 −1 +1. If subcarrier N+4 is under interference, then the remaining sequences lose their orthogonality. Thus, the UE decides to abandon subcarrier N+3 to reduce to SF2. The new spreading sequences may be defined by as illustrated in FIG. 7B where stream a with sequence a is +1 +1; stream b with sequence b is +1 +1; stream c with sequence c is +1 −1; and stream d sequence d is +1 −1.

In the new spreading sequences, as illustrated in FIG. 7B, the sequences a and b have become identical. Additionally, sequences c and d are now identical. However, sequence a is orthogonal to sequence c over subcarriers N and N+1; and sequence b is orthogonal to sequence d over carriers N and N+1. Thus, the new spreading sequences are orthogonal over two subcarriers, i.e., a spreading factor of two is available. An eNodeB may decide to choose only sequences a and c, and not use sequences b or d, or vice versa.

FIG. 8A illustrates a method 801 for transmitting and receiving signals in the presence of strong interference. At block 810, a signal is received for spreading over a first subcarrier and a second subcarrier. At block 812, the eNodeB determines the first subcarrier is subject to interference. The received signal is decoded on a second subcarrier without demodulating the signal on the first subcarrier, at block 814.

FIG. 8B illustrates a method 802 for transmitting and receiving signals at the eNodeB in the presence of strong interference. At block 820, a eNodeB generates a signal to be spread over a first subcarrier and a second subcarrier. The signal corresponds to multiple streams. At block 822 it is determined that the first subcarrier is subject to interference. Less than all of the streams on the second subcarrier are transmitted at block 824.

In one configuration, the UE 120 is configured for wireless communication including means for receiving a signal. In one aspect, the receiving means may be the receive processor 458, demodulators 452a-t, controller/processor 480, memory 482, and antenna 452a-t configured to perform the functions recited by the receiving means. The UE 120 is also configured to include a means for determining. In one aspect, the determining means may be the controller/processor 480 and memory 482 configured to perform the functions recited by the determining means. The UE 120 is also configured to include a means for decoding. In one aspect, the decoding means may be the controller/processor 480 and memory 482 configured to perform the functions recited by the decoding means. In another aspect, the aforementioned means may be a module or any apparatus configured to perform the functions recited by the aforementioned means.

In one configuration, the eNodeB 110 is configured for wireless communication including means for generating a signal. In one aspect, the generating means may be the controller/processor 440 and memory 442 configured to perform the functions recited by the generating means. The eNodeB 110 is also configured to include a means for determining. In one aspect, the determining means may be the controller/processor 440 and memory 442 configured to perform the functions recited by the determining means. The eNodeB 110 is also configured to include a means for transmitting. In one aspect, the transmitting means may be the controller/processor 440, memory 442, transmit processor 420, modulators 432a-t, and antenna 434a-t configured to perform the functions recited by the transmitting means. In another aspect, the aforementioned means may be a module or any apparatus configured to perform the functions recited by the aforementioned means.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for communicating in a wireless network, comprising:
receiving a signal intended to be spread over a first subcarrier and a second subcarrier;
determining the first subcarrier is subject to interference; and
decoding the received signal on the second subcarrier without demodulating the signal on the first subcarrier when the first subcarrier is subject to interference.

2. The method of claim 1, in which decoding the received signal comprises at least one of:
ignoring the signal received on the first subcarrier and not using the signal received on the first subcarrier.

3. The method of claim 1, in which the received signal is coded by space frequency block codes (SFBC) on consecutive subcarriers.

4. The method of claim 1, in which the decoding the received signal comprises despreading on the second subcarrier while ignoring the first subcarrier.

5. A method for communicating in a wireless network, comprising:
generating a signal to be spread over a first subcarrier and a second subcarrier, the signal corresponding to multiple streams;
determining the first subcarrier is subject to interference; and
transmitting the signal on fewer than all streams over the second subcarrier when the first subcarrier is subject to interference.

6. The method of claim 5, in which the transmitting comprises selecting a different spreading code, which is orthogonal while ignoring the first subcarrier.

7. The method of claim 5, in which the transmitting comprises at least one of rate matching a plurality of space frequency block codes (SFBC) streams and puncturing at least one of a plurality of SFBC streams.

8. An apparatus for wireless communication, comprising:
means for receiving a signal intended to be spread over a first subcarrier and a second subcarrier;
means for determining the first subcarrier is subject to interference; and
means for decoding the received signal on the second subcarrier without demodulating the signal on the first subcarrier when the first subcarrier is subject to interference.

9. The apparatus of claim 8, in which the decoding means comprises at least one of: means for ignoring the signal received on the first subcarrier and means for not using the signal received on the first subcarrier.

10. An apparatus for wireless communication, comprising:
means for generating a signal to be spread over a first subcarrier and a second subcarrier, the signal corresponding to multiple streams;
means for determining the first subcarrier is subject to interference; and
means for transmitting the signal on fewer than all streams over the second subcarrier when the first subcarrier is subject to interference.

11. The apparatus of claim 10, in which the transmitting means selects a different spreading code, which is orthogonal while ignoring the first subcarrier.

12. A computer program product for wireless communication in a wireless network, comprising:
a computer-readable medium having non-transitory program code recorded thereon, the program code comprising:
program code to receive a signal intended to be spread over a first subcarrier and a second subcarrier;
program code to determine the first subcarrier is subject to interference; and
program code to decode the received signal on the second subcarrier without demodulating the signal on the first subcarrier when the first subcarrier is subject to interference.

13. A computer program product for wireless communication in a wireless network, comprising:
a computer-readable medium having non-transitory program code recorded thereon, the program code comprising:
program code to generate a signal to be spread over a first subcarrier and a second subcarrier, the signal corresponding to multiple streams;
program code to determine the first subcarrier is subject to interference; and
program code to transmit the signal on fewer than all streams over the second subcarrier when the first subcarrier is subject to interference.

14. An apparatus for wireless communication, comprising:
a memory; and
at least one processor coupled to the memory, the at least one processor being configured:
to receive a signal intended to be spread over a first subcarrier and a second subcarrier;
to determine the first subcarrier is subject to interference; and
to decode the received signal on the second subcarrier without demodulating the signal on the first subcarrier when the first subcarrier is subject to interference.

15. The apparatus of claim 14, in which the at least one processor is further configured to decode by performing at least one of: ignoring the signal received on the first subcarrier and not using the signal received on the first subcarrier.

16. The apparatus of claim 14, in which the signal is coded by space frequency block codes (SFBC) on consecutive subcarriers.

17. The apparatus of claim 14, in which the at least one processor is further configured to decode by despreading the received signal on the second subcarrier while ignoring the first subcarrier.

18. An apparatus for wireless communication, comprising:
a memory; and
at least one processor coupled to the memory, the at least one processor being configured:
to generate a signal to be spread over a first subcarrier and a second subcarrier, the signal corresponding to multiple streams;
to determine the first subcarrier is subject to interference; and
to transmit the signal on fewer than all streams over the second subcarrier when the first subcarrier is subject to interference.

19. The apparatus of claim 18, in which the at least one processor is configured to transmit by selecting a different spreading code, which is orthogonal while ignoring the first subcarrier.

20. The apparatus of claim 18, in which the at least one processor is configured to transmit by at least one of rate matching a plurality of space frequency block codes (SFBC) streams and puncturing at least one of the plurality of (SFBC) streams.
